(19) United States
(12) Patent Application Publication
(10) Pub. No.: US 2026/0163270 A1
(43) Pub. Date: Jun. 11, 2026

(54) PLUG CONNECTOR, RECEPTACLE CONNECTOR AND CONNECTOR ASSEMBLY

(71) Applicant: Molex, LLC, Lisle, IL (US)

(72) Inventors: Lie Chen, Maumelle, AR (US); Chun-Chieh Yang, New Taipei City (TW); Chung-Han Tsai, New Taipei City (TW); Che-Yuan Yang, New Taipei City (TW); Po-Wen Chen, New Taipei City (TW); Hui Hsuan Yang, New Taipei City (TW)

(21) Appl. No.: 19/243,037

(22) Filed: Jun. 19, 2025

(30) Foreign Application Priority Data
Dec. 5, 2024 (CN) 202411777372.5

(51) Int. Cl. H01R 12/72; H01R 12/70; H01R 12/71; H01R 13/24; H01R 13/6587; H01R 13/6595

(52) U.S. Cl. CPC H01R 12/727; H01R 12/707; H01R 12/714; H01R 13/24; H01R 13/6587; H01R 13/6595

(57) ABSTRACT

A plug connector, a receptacle connector and a connector assembly are disclosed. The plug connector includes a board and at least one ground shielding cover. The board has a board mating portion, a surface of the board mating portion is provided with multiple pairs of signal conductive pads and multiple ground conductive pads which are respectively provided at two sides of each pair of signal conductive pads. The at least one ground shielding cover is mounted the surface of the board, the ground shielding cover and the board together encircle at least parts of the multiple pairs of signal conductive pads. The receptacle connector includes multiple pairs of signal terminals and multiple ground terminals. When the plug connector and the receptacle connector mate with each other, the multiple ground terminals of the receptacle connector are electrically connected with the ground shielding cover, each pair of signal terminals of the receptacle connector are electrically connected the corresponding pair of signal conductive pads, wherein the ground shielding cover covers and shields free ends of the multiple pairs of signal terminals.

### TECHNICAL FIELD

The present disclosure relates to a connector assembly, and particularly relates to a connector assembly which includes a plug connector and a receptacle connector.

### BACKGROUND

Chinese patent document CN105529547B discloses a shielding assembly, which includes a shielding part, has a canal-like receptacle. The canal-like receptacle extends along an entire connection region and is adapted to receive signal lines. The shielding part and the shielding assembly provide shielding efficiency in the connection region and at the same time have a shape that allows an easy production and mounting of the shielding part and the shielding assembly. The shielding part has a U-shaped cross-section. In other embodiments, the shielding part also can have a V- or C-shaped cross-section. The shielding part with the U-shaped cross-section has a common base that joins two legs (or side sections), that are located on longitudinal sides of the cable assembly. The common base and the legs thus extend along a cable direction. The shielding part can further have an open longitudinal side. Through this open longitudinal side, the signal lines can be connected to a PCB. The PCB can include a conductive layer, in particular a grounding layer, so that the shielding part together with the PCB shield the connection region 360° around the cable direction.

Chinese patent document CN106463858B discloses a cable connector, which includes a shielding structure that is mounted to a substrate and is electrically connected to a grounding pad. The shielding structure includes a cap and a plurality of sidewalls extending from the cap to the substrate. Each of transmitting and receiving cables is positioned between a different pair of side walls.

Chinese patent document CN114389113A discloses a first shield component, which is in form of a pair of first shielding plates, each of the pair of first shielding plates extends at least along an entire length of a corresponding terminal row in a longitudinal direction, and extends at least along tail portions of multiple ground terminals and a transverse bar of the corresponding terminal row in a transverse direction. When cables are connected to a plurality of conductive terminals of a cable connector, the pair of first shielding plates each are mounted on the multiple ground terminals of the corresponding terminal row from an outer side of each of the two terminal rows (for example by laser welding) and contact the multiple ground terminals, and press against shielding conductors and contact the shielding conductors, so as to maintain the shielding conductors on the transverse bar and make the shielding conductors contact the transverse bar. By this, the first shield component, the ground terminals, the transverse bars and the shielding conductors together encircle connected locations between the signal conductors and signal terminals to form shielding, so that signal integrity of signal transmission between the cables and the cable connector is promoted.

Chinese patent document CN116073193A discloses a ground bus which is coupled to a circuit card. The ground bus may be electrically connected to the circuit card, such as to a ground plane of the circuit card. The ground bus provides electrical shielding for signal conductors of cables. The ground bus is electrically connected to the shield structures of the cables, such as to ground shields of the cables and/or drain wires of the cables. In an exemplary embodiment, the ground bus is soldered to the ground shields. The ground bus extends along exposed portions and provides shielding for the exposed portions. The ground bus is shaped and positioned relative to the exposed portions to control impedance along signal paths.

Chinese patent document CN116191136A discloses, by that a first ground piece and a second ground piece are provided and the first ground piece and the second ground piece are provided between first mating portions and second mating portions along a thickness direction of a tongue, mutual interference between the first mating portions of the first conductive terminals and the second mating portions of the second conductive terminals in signal transmission is lowered, quality of signal transmission is promoted.

Chinese patent document CN117096679A discloses that, multiple ground terminals are spaced apart from each other and are provided on a surface of plastic base, are used to electrically contact ground terminals in a female-end connector. Every two ground terminal is provided therebetween with one first signal terminal group (that is, two first signal terminals) to electromagnetically shield the first signal terminals of the first signal terminal group. An electrical connecting structure is embeded in a first insulator of the plastic base. The electrical connecting structure and the multiple ground terminals are fixed and electrically connected with each other to connect the multiple ground terminals together in series to form an integral net-like structure of common-ground, which realizes a common-ground effect similar to through holes of a PCB, promotes electromagnetic shielding effect between each first signal terminal group, in turn promotes crosstalk performance of a cable module, promotes quality of signal transmission of the cable module.

However, with respect to a connector with a different construction, it still needs to research and develop various electromagnetic shielding designs so as to prevent electromagnetic interference from affecting signal transmission, and to make that the connector can have higher signal integrity at a high transmission speed.

### SUMMARY

Therefore, an object of the present disclosure is to provide a plug connector, a receptacle connector and a connector assembly which can improve a problem of the prior art.

Accordingly, in some embodiments, a plug connector of the present disclosure comprises a board and at least one ground shielding cover. The board has a board mating portion, a surface of the board mating portion is provided with multiple pairs of signal conductive pads and multiple ground conductive pads which are respectively provided at two sides of each pair of signal conductive pads. The at least one ground shielding cover is mounted the surface of the board, the ground shielding cover and the board together encircle at least parts of the multiple pairs of signal conductive pads.

In some embodiments, the ground shielding cover has multiple contact portions which respectively contact the multiple ground conductive pads, multiple wall portions which are positioned between the multiple contact portions and are respectively spaced apart from and correspond to the multiple pairs of signal conductive pads, and multiple connecting portions which respectively connect the multiple contact portions and the multiple wall portions.

In some embodiments, the plug connector further comprises a plug housing, the ground shielding cover further comprises multiple fixing portions which are formed by bending respectively from the multiple wall portions toward a direction away from the multiple connecting portions, the plug housing clads the multiple fixing portions and a part of the ground shielding cover.

In some embodiments, each contact portion has a bulging bar which bulges toward the board and toward a direction away from the wall portion, the bulging bar is used to press against the ground conductive pad.

In some embodiments, the plug connector comprises the two ground shielding covers respectively provided to the two surfaces of the board which are in opposite sides.

In some embodiments, the contact portions of the two ground shielding covers correspond to each other and are connected with connecting segments.

In some embodiments, the multiple wall portions are connected as a flat plate shape.

In some embodiments, surfaces of one sides of the multiple connecting portions each are formed with a receiving recessed groove.

In some embodiments, the multiple connecting portions each have a contact oblique surface in a direction which faces an inserting direction.

In some embodiments, the multiple contact portions, the multiple wall portions and the multiple connecting portions are the same in length along a front-rear direction.

In some embodiments, the multiple wall portions are longer than the multiple contact portions in length along the front-rear direction.

In some embodiments, the board further comprises a board connecting portion which is electrically connected with the board mating portion.

In some embodiments, a surface of the board connecting portion is provided with multiple pairs of signal conductive pads and multiple ground conductive pads which are respectively provided at two sides of each pair of signal conductive pads.

A receptacle connector of the present disclosure comprises an insulative body, a terminal module, at least one first ground shielding member and at least one second ground shielding member. The terminal module is provided to the insulative body, the terminal module comprises a terminal group and an insulative base. The terminal group comprises multiple pairs of signal terminals and multiple ground terminals, the insulative base partially clads the terminal group. The first ground shielding member is positioned at one sides of the multiple ground terminals. The second ground shielding member is positioned at the other sides of the multiple ground terminals, the first ground shielding member, the second ground shielding member and the multiple ground terminals together encircle the multiple pairs of signal terminals.

In some embodiments, the first ground shielding member is electrically connected with one sides of the multiple ground terminals in an up-down direction, the second ground shielding member is electrically connected with the other sides of the multiple ground terminals in the up-down direction.

In some embodiments, the signal terminal and the ground terminal each comprise a fixing segment and a soldering segment bends relative to the fixing segment, the first ground shielding member comprises a first shielding region and a second shielding region which are connected with each other to be substantially in form of L-shape, the first shielding region is used to shield the fixing segments of the multiple pairs of signal terminals, the second shielding region is used to shield the soldering segments of the multiple pairs of signal terminals.

In some embodiments, the first shielding region and the second shielding region each have multiple contact portions which are electrically connected with the multiple ground terminals respectively, multiple wall portions which are respectively positioned between the multiple contact portions and are respectively correspond to the multiple pairs of signal terminals, and multiple connecting portions which each are connected between the adjacent contact portion and the adjacent wall portion.

In some embodiments, the first ground shielding member further comprises multiple sleeve portions and multiple connecting segments, the multiple sleeve portions respectively sheathe the fixing segments of the multiple ground terminals, the multiple connecting segments respectively connect the multiple sleeve portions and the multiple contact portions of the second shielding region.

In some embodiments, the first ground shielding member further comprises multiple folded-back connecting portions, the multiple folded-back connecting portions each are folded back from each wall portion of the second shielding region, extend toward the fixing segments of the multiple pairs of signal terminals, and connect one wall portion of the first shielding region.

In some embodiments, two protruding pieces respectively extend front and rear along a front-rear direction from each sleeve portion of the first ground shielding member, the receptacle connector comprises the two second ground shielding members, the two second ground shielding members are spaced apart from each other along the front-rear direction and respectively contact the protruding pieces of the sleeve portions of the first ground shielding member.

In some embodiments, each ground terminal has a contact segment, the contact segment bends and bulges along a left-right direction.

In some embodiments, each ground terminal has a contact segment, the contact segment bends and bulges along an up-down direction.

In some embodiments, the first ground shielding member further comprises multiple connecting segments, the multiple connecting segments are respectively connected between the multiple wall portions of the first shielding region and the multiple wall portions of the second shielding region.

In some embodiments, the receptacle connector comprises the two second ground shielding members, the two second ground shielding members are spaced apart from each other along a front-rear direction and respectively contact the fixing segments of the multiple ground terminals.

In some embodiments, each ground terminal has a contact segment, the contact segment is a pair of clamping pieces.

In some embodiments, the first ground shielding member comprises multiple wall portions and multiple pressing portions, the multiple wall portions are respectively spaced apart from and correspond to the multiple pairs of signal terminals, the multiple pressing portions are in form of elastic arm structure and contact the multiple ground terminals.

In some embodiments, the first ground shielding member has multiple contact portions, multiple wall portions which are positioned between the multiple contact portions and respectively correspond to the multiple pairs of signal terminals, and multiple connecting portions which respectively connect the multiple contact portions and the multiple wall portions, the multiple contact portions are used to contact the multiple ground terminals respectively.

In some embodiments, each ground terminal has a metal portion which is a metal material and a conductive plastic portion which is formed by that an electrical conductive plastic clads the metal portion, the multiple contact portions of the first ground shielding member each are cladded by the conductive plastic portion.

In some embodiments, each ground terminal comprises a fixing segment and a soldering segment which bends relative to the fixing segment, the second ground shielding member has a second ground shielding piece and multiple bushing portions, the multiple bushing portions respectively sheathe the fixing segments and the soldering segments of the multiple ground terminals and one ends of the multiple bushing portions contact the second ground shielding piece.

In some embodiments, the first ground shielding member is provided in the insulative body, and the first ground shielding member is in form of sheet shape and is spaced apart the multiple pairs of signal terminals.

A connector assembly of the present disclosure comprises a plug connector and a receptacle connector, the plug connector comprises a board and at least one ground shielding cover. The board has a board mating portion, a surface of the board mating portion is provided with multiple pairs of signal conductive pads and multiple ground conductive pads which are respectively provided at two sides of each pair of signal conductive pads. The at least one ground shielding cover is mounted the surface of the board, the ground shielding cover and the board together encircle at least parts of the multiple pairs of signal conductive pads. The receptacle connector comprises multiple pairs of signal terminals and multiple ground terminals. When the plug connector and the receptacle connector mate with each other, the multiple ground terminals of the receptacle connector are electrically connected with the ground shielding cover, each pair of signal terminals of the receptacle connector are electrically connected the corresponding pair of signal conductive pads, wherein the ground shielding cover covers and shields free ends of the multiple pairs of signal terminals.

The ground shielding cover and the board of the plug connector of the present disclosure together encircle at least parts of the multiple pairs of signal conductive pads on the board mating portion of the board. Moreover, the first ground shielding member, the second ground shielding member and the multiple ground terminals of the receptacle connector of the present disclosure together encircle the multiple pairs of signal terminals of the terminal module. Furthermore, when the plug connector and the receptacle connector mate with each other, the multiple ground terminals of the receptacle connector are electrically connected with the ground shielding cover, the multiple pairs of signal terminals of the receptacle connector are electrically connected with the corresponding multiple pairs of signal conductive pads, where, the ground shielding cover covers and shields the free ends of the multiple pairs of signal terminals or the free ends and the contact portions of the multiple pairs of signal terminals. Therefore, it can prevent electromagnetic interference from affecting signal transmission, so the connectors can have higher signal integrity at a high transmission speed.

### BRIEF DESCRIPTION OF THE DRAWINGS

Other features and effects of the present disclosure will be apparent from embodiments with reference to the drawings, in which:

FIG. 1 is a perspective view of a first embodiment of a connector assembly of the present disclosure, in which a plug connector and a receptacle connector of the connector assembly do not mate with each other;

FIG. 2 is a perspective view of the first embodiment, in which the plug connector and the receptacle connector of the connector assembly do not mate with each other, and a plug housing of the plug connector and a receptacle housing and an insulative body of the receptacle connector are omitted;

FIG. 3 is a perspective view of the first embodiment illustrating two terminal groups of the receptacle connector of the connector assembly with each terminal group including a first ground shielding member;

FIG. 4 is a partially enlarged view of FIG. 3 illustrating an assembling state of the first ground shielding member and signal terminals and ground terminals;

FIG. 5 is a cross sectional view of the receptacle connector of the first embodiment, in which the receptacle housing and the insulative body of the receptacle connector are omitted;

FIG. 6 is a perspective view of the first embodiment, in which the plug connector and the receptacle connector of the connector assembly have mated with each other, and the plug housing and a cladding body of the plug connector and the receptacle housing, the insulative body and an insulative base of the receptacle connector are omitted;

FIG. 7 is a perspective view of a plug connector of a second embodiment of the connector assembly of the present disclosure;

FIG. 8 is an exploded perspective view of the plug connector of the second embodiment;

FIG. 9 is a cross sectional view of the plug connector of the second embodiment;

FIG. 10 is a perspective view of a third embodiment of the connector assembly of the present disclosure, in which the plug connector and the receptacle connector of the connector assembly do not mate with each other;

FIG. 11 is a perspective view of the third embodiment illustrating a structure of a first ground shielding member of the plug connector;

FIG. 12 is a perspective view of the third embodiment, in which the plug connector and the receptacle connector of the connector assembly do not mate with each other, and the plug housing of the plug connector and the receptacle housing and the insulative body of the receptacle connector are omitted;

FIG. 13 is a perspective view of the third embodiment illustrating a structure of a first ground shielding member of the receptacle connector;

FIG. 14 is a perspective view of the third embodiment, in which the plug connector and the receptacle connector of the connector assembly have mated with each other, and the plug housing and the cladding body of the plug connector and the receptacle housing, the insulative body and the insulative base of the receptacle connector are omitted;

FIG. 14A is perspective view of a variation of the third embodiment, in which two ground shielding covers are connected with connecting segments;

FIG. 15 is a perspective view of a fourth embodiment of the connector assembly of the present disclosure, in which the plug connector and the receptacle connector of the connector assembly do not mate with each other;

FIG. 16 is a perspective view of the fourth embodiment, in which the plug connector and the receptacle connector of the connector assembly do not mate with each other, and the plug housing of the plug connector and the receptacle housing and the insulative body of the receptacle connector are omitted;

FIG. 17 is a perspective view of the fourth embodiment, in which the plug connector and the receptacle connector of the connector assembly have mated with each other, and the plug housing and the cladding body of the plug connector and the receptacle housing, the insulative body and the insulative base of the receptacle connector are omitted;

FIG. 18 is a perspective view of the fourth embodiment illustrating a state that a pair of clamping pieces of a first ground shielding member of the receptacle connector clamp a ground shielding cover of the plug connector;

FIG. 19 is a perspective view of a fifth embodiment of the connector assembly of the present disclosure, in which the plug connector and the receptacle connector of the connector assembly do not mate with each other;

FIG. 20 is a perspective view of the receptacle connector of the fifth embodiment;

FIG. 21 is a cross sectional view of the receptacle connector of the fifth embodiment;

FIG. 22 is a perspective view of the fifth embodiment, in which the plug connector and the receptacle connector of the connector assembly do not mate with each other, and the plug housing of the plug connector and the receptacle housing and the insulative body of the receptacle connector are omitted;

FIG. 23 is a perspective view of the fifth embodiment, in which the plug connector and the receptacle connector of the connector assembly have mated with each other, and the plug housing and the cladding body of the plug connector and the receptacle housing, the insulative body and the insulative base of the receptacle connector are omitted;

FIG. 24 is a perspective view of a sixth embodiment of the connector assembly of the present disclosure, in which the plug connector and the receptacle connector of the connector assembly do not mate with each other;

FIG. 25 is a perspective view of the sixth embodiment, in which the plug connector and the receptacle connector of the connector assembly do not mate with each other, and the plug housing of the plug connector and the receptacle housing and the insulative body of the receptacle connector are omitted;

FIG. 26 is a perspective view of the sixth embodiment, in which the plug connector and the receptacle connector of the connector assembly have mated with each other, and the plug housing and the cladding body of the plug connector and the receptacle housing, the insulative body and the insulative base of the receptacle connector are omitted;

FIG. 27 is a cross sectional view of the receptacle connector of the sixth embodiment;

FIG. 28 is a perspective view of a receptacle connector of a seventh embodiment of connector assembly of the present disclosure, in which the receptacle housing and the insulative body of the receptacle connector are omitted;

FIG. 29 is a perspective view of a seventh embodiment illustrating a form of a first ground shielding member of the receptacle connector, in which conductive plastic portions of a part of ground terminals are removed;

FIG. 30 is a cross sectional view of the receptacle connector of the seventh embodiment, in which the receptacle housing the insulative body and the insulative base of the receptacle connector, are omitted;

FIG. 31 is a perspective view of a receptacle connector of an eighth embodiment of the connector assembly of the present disclosure, in which the receptacle housing and the insulative body of the receptacle connector are omitted;

FIG. 32 is a cross sectional view of the receptacle connector of the eighth embodiment, in which the receptacle housing and the insulative body of the receptacle connector are omitted; and

FIG. 33 is a perspective view of the eighth embodiment illustrating a structure of a first ground shielding member of the receptacle connector.

### DETAILED DESCRIPTION

Before the present disclosure is described in detail, it is noted that the similar elements are indicated by the same reference numerals in the following described content.

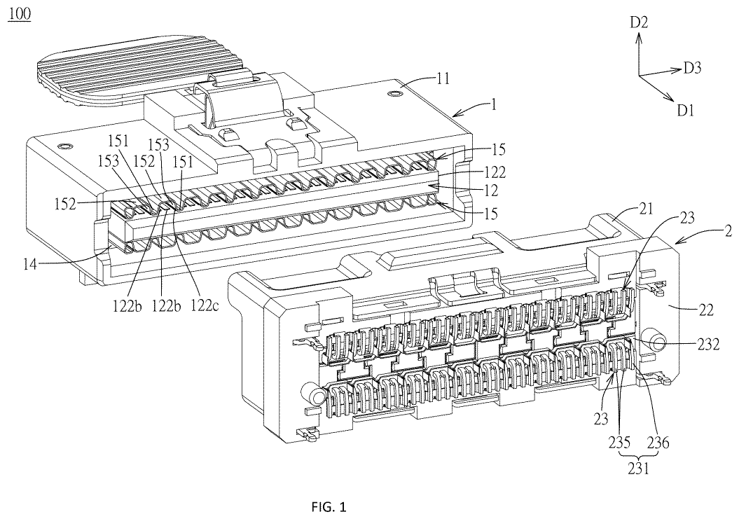

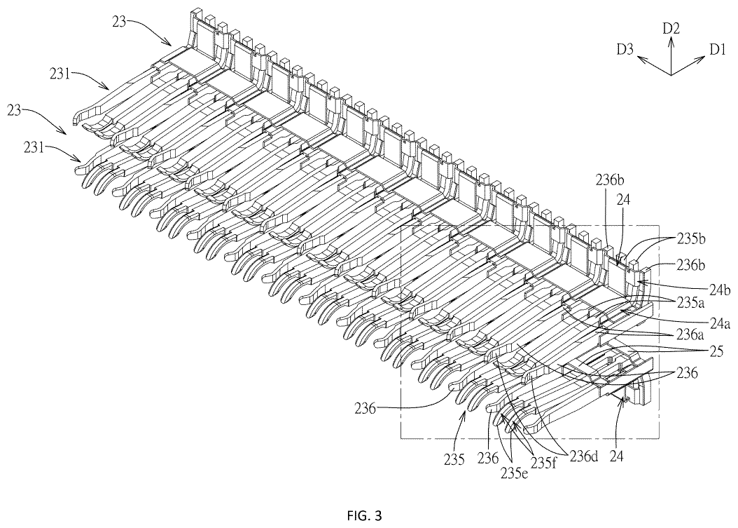

Referring to FIG. 1 to FIG. 4 and FIG. 6, a first embodiment of a connector assembly 100 of the present disclosure includes a plug connector 1 and a receptacle connector 2.

The plug connector 1 includes a plug housing 11, a board 12, a plurality of cables 13, a cladding body 14, and at least one ground shielding cover 15 which is mounted on a surface of the board 12. In the present embodiment, the board 12 is a circuit board, but in other varied forms, the board 12 also may be an equivalent construction of a circuit board, for example a circuit board-like form which is composed of a metal and a plastic. The board 12 has a board connecting portion 121 and a board mating portion 122 which are respectively positioned front and rear along a front-rear direction D1 (an arrow is toward the front), the board connecting portion 121 and the board mating portion 122 are electrically connected, and the board 12 has an upper surface and a lower surface which are respectively toward the up and the down along an up-down direction D2 (an arrow is toward the up). An upper surface and a lower surface of the board connecting portion 121 each are provided with multiple pairs of signal conductive pads 121a which are spaced apart from each other and arranged side by side along a left-right direction D3 (an arrow is toward the right), and multiple ground conductive pads 121b which are respectively provided at two sides of each pair of signal conductive pads 121a, the plurality of cables 13 are electrically connected to the pairs of signal conductive pads 121a and the ground conductive pads 121b on the board connecting portion 121 respectively, and by that the cladding body 14 clads connected locations between the board connecting portion 121 and the plurality of cables 13, the board 12, the plurality of cables 13 and the cladding body 14 together are assembled to the plug housing 11. An upper surface and a lower surface of the board mating portion 122 each are provided with multiple pairs of signal conductive pads 122b which are spaced apart from each other and arranged side by side along the left-right direction D3, and multiple ground conductive pads 122c which are respectively provided at two sides of each pair of signal conductive pads 122b, that is, a left side and a right side of each pair of signal conductive pad 122b each are provided with the ground conductive pad 122c. In the present embodiment, the board connecting portion 121 of the board 12 is connected with the plurality of cables 13, but in other implementing manners, the board connecting portion 121 of the board 12 also may be connected with a circuit board.

The first embodiment is provided with the two ground shielding covers 15. The two ground shielding covers 15 are formed by bending a metal sheet. The two ground shielding covers 15 are respectively mounted on the upper surface and the lower surface of the board 12 and each contact the corresponding multiple ground conductive pads 122c. Specifically, each ground shielding cover 15 has multiple contact portions 151 which respectively contact the multiple ground conductive pads 122c, multiple wall portions 152 which are positioned between the multiple contact portions 151 and are respectively spaced apart from and correspond to the multiple pairs of signal conductive pads 122b, and multiple connecting portions 153 which respectively connect the multiple contact portions 151 and the multiple wall portions 152. In the first embodiment, the contact portion 151 and the wall portion 152 extend substantially along the left-right direction D3 and are spaced apart from each other in the up-down direction D2 to be staggered with each other, the connecting portion 153 extends substantially along the up-down direction D2 and connects the contact portion 151 and the wall portion 152, a cross section of the wall portion 152 and the connecting portions 153, which are connected with each other, in the up-down direction D2 is substantially in form of inverted U-shape, and the wall portion 152 and the connecting portions 153 each have an shielding effect, a cross section of the contact portion 151 and the connecting portions 153, which are connected with each other, in the up-down direction D2 is substantially in form of U-shape, so that the ground shielding cover 15 entirely is substantially in form of wave shape, and the multiple contact portion 151, the multiple wall portion 152 and the multiple connecting portion 153 are the same in length along the front-rear direction D1. Each wall portion 152 is maintained to be spaced apart from the corresponding pair of signal conductive pads 122b in the up-down direction D2, so that the ground shielding cover 15 and the board 12 together encircle the multiple pairs of signal conductive pads 122b. In the first embodiment, the multiple contact portions 151 of the ground shielding cover 15 are respectively fixed on the multiple ground conductive pads 122c of the board 12 by soldering, but the present disclosure is not limited thereto. Preferably, the board 12 is provided therein with a ground layer (not shown) which is parallel to the upper surface and the lower surface of the board 12. Preferably, the ground layer is electrically connected with the multiple ground conductive pads 122c.

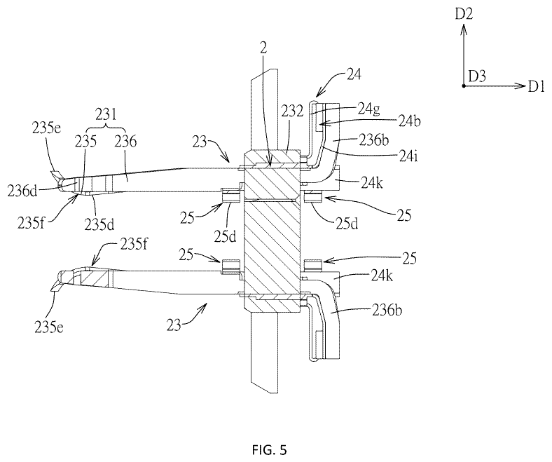

Referring to FIG. 1 and FIG. 3 to FIG. 5, the receptacle connector 2 is used to mate with the plug connector 1. The receptacle connector 2 includes a receptacle housing 21 which is a metal material, an insulative body 22 which is a plastic material, two terminal modules 23, at least one first ground shielding member 24, and at least one second ground shielding members 25. The insulative body 22 is provided to the receptacle housing 21, the two terminal modules 23 are provided side by side in the insulative body 22. Each terminal module 23 includes a terminal group 231 and an insulative base 232. The terminal group 231 includes multiple pairs of signal terminals 235 and multiple ground terminals 236 which are arranged along the left-right direction D3, where the multiple ground terminals 236 are respectively provided at two sides of the each pair of signal terminals 235. The signal terminal 235 and the ground terminal 236 each have a fixing segment 235a, 236a, a soldering segment 235b, 236b which extends along the arrow direction of the front-rear direction D1 from the fixing segment 235a, 236a and bends relative to the fixing segment 235a, 236a, and an elastic arm segment 235c, 236c which extends opposite to the arrow direction of the front-rear direction D1 from the fixing segment 235a, 236a, and a contact segment 235d, 236d which extends from the elastic arm segment 235c, 236c and is in form of curved shape. The insulative base 232 partially clads the terminal group 231, that is, the fixing segments 235a, 236a of the signal terminals 235 and the multiple ground terminals 236, to retain the terminal group 231. The contact segment 235d of each signal terminal 235 has a free end 235e and a contact portion 235f which is used to contact the signal conductive pad 122b, and in the first embodiment, the contact segment 236d of each ground terminal 236 bends and bulges along the left-right direction D3.

In the first embodiment, one first ground shielding member 24 is provided for each terminal module 23, the first ground shielding member 24 is provided to the terminal group 231 along the left-right direction D3, and is electrically connected with one sides of the multiple ground terminals 236 in the up-down direction D2, and is positioned to a side of the fixing segment 236a and the soldering segment 236b where bending are toward each other. In the first embodiment, the first ground shielding member 24 is formed by bending a metal sheet. The first ground shielding member 24 includes a first shielding region 24a and a second shielding region 24b which are connected with each other and substantially is in form of L-shape, the first shielding region 24a and the second shielding region 24b each entirely are substantially in form of wave shape, where, the first shielding region 24a is used to shield the fixing segments 235a of the signal terminals 235, the second shielding region 24b is used to shield the soldering segments 235b of the signal terminals 235, the first shielding region 24a and the second shielding region 24b each have multiple contact portions 24c which are electrically connected with the multiple ground terminals 236, multiple wall portions 24d which are positioned between the multiple contact portions 24c and respectively correspond to the multiple pairs of signal terminals 235, and multiple connecting portions 24e which each are connected between the adjacent contact portion 24c and the adjacent wall portion 24d. The multiple contact portions 24c of the first shielding region 24a are electrically connected to the fixing segments 236a of the multiple ground terminals 236 respectively, the multiple wall portions 24d of the first shielding region 24a are connected between the multiple contact portions 24c respectively via the multiple connecting portions 24e to respectively span the fixing segments 235a of the multiple pairs of the signal terminals 235 and respectively be spaced apart from the fixing segment 235a of the multiple pairs of signal terminals 235, each wall portion 24d and the two connecting portions 24e are connected to form a shielding structure which is in form of inverted U-shape, and the wall portion 24d and the two connecting portions 24e each have a shielding effect. The multiple contact portions 24c of the second shielding region 24b are welded and fixed to the soldering segments 236b of the multiple ground terminals 236 respectively, the multiple wall portions 24d of the second shielding region 24b are connected between the multiple contact portions 24c respectively via the multiple connecting portions 24e to respectively span the soldering segments 235b of the multiple pairs of the signal terminals 235b and respectively be spaced apart from the soldering segments 235b of the multiple pairs of the signal terminals 235b.

In addition, in the first embodiment, the first ground shielding member 24 further includes multiple folded-back connecting portions 24g, multiple sleeve portions 24h and multiple connecting segments 24i, where, the folded-back connecting portion 24g is folded back from the second shielding region 24b of each wall portion 24d, extends toward the fixing segments 235a of the signal terminals 235 to be similarly spaced apart from and correspond to the soldering segments 235b of the signal terminals 235b, and connects one wall portion 24d of the first shielding region 24a, the multiple sleeve portions 24h respectively sheathe the fixing segments 236a of the multiple ground terminals 236, and the contact portion 24c of the aforementioned first shielding region 24a is electrically connected to the fixing segment 236a of the ground terminal 236 by being welded to the sleeve portion 24h, and in the first embodiment, each sleeve portion 24h of the first ground shielding member 24 respectively extends front and rear to respectively form a protruding pieces 24j and a protruding piece 24k whose function will be described later, the connecting segment 24i connects the sleeve portion 24h and the contact portion 24c of the second shielding region 24b, and substantially attaches to the soldering segment 236b of the ground terminal 236.

In the first embodiment, the two second ground shielding members 25 are provided for each terminal module 23, the two second ground shielding members 25 are substantially in form of strip wave shape, are spaced apart from each other along the front-rear direction D1, and are positioned respectively at a front side and a rear side of the insulative base 232. Each second ground shielding members 25 has multiple contact portions 25c, multiple wall portions 25d which are positioned between the multiple contact portions 25c and respectively correspond to the multiple pairs of signal terminals 235, and multiple connecting portions 25e which each are connected between the adjacent contact portion 25c and the adjacent wall portion 25d, and the wall portion 25d and the connecting portions 25e each have an shielding effect, the two second ground shielding members 25 respectively contact the protruding pieces 24j and the protruding pieces 24k of the multiple sleeve portions 24h of the first ground shielding member 24 via the contact portions 25c to be electrically connected with the multiple ground terminals 236, and are positioned to the other sides of the multiple ground terminals 236 in the up-down direction D2 relative to the first ground shielding member 24. Therefore, with respect to each terminal module 23, by that the two second ground shielding members 25 and the first ground shielding member 24 cooperate with the ground terminals 236 to encircle the fixing segments 235a and the soldering segments 235b of the signal terminals 235, a better shielding effect may be attained. It is noted that, in other implementing manners, the second ground shielding member 25 also may be provided as only one or three or more. Moreover, in the first embodiment, the first ground shielding member 24 may be provided to the insulative base 232 by insert molding to press against the multiple ground terminals 236 and be electrically connected to the multiple ground terminals 236. The second ground shielding members 25 is provided to the first ground shielding member 24 by welding to be electrically connected to the multiple ground terminals 236 via the first ground shielding member 24.

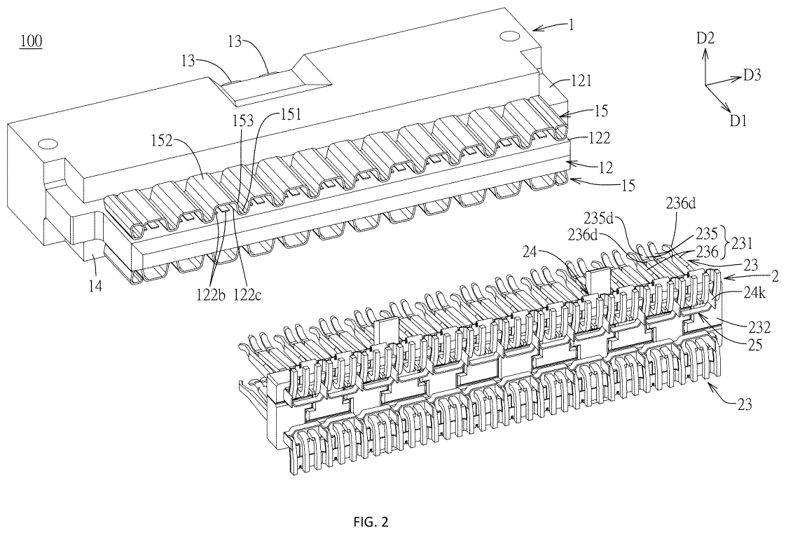

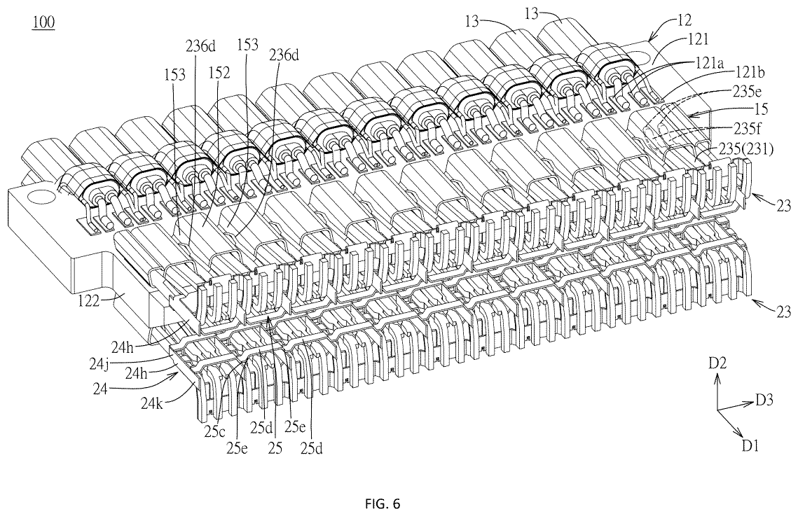

Referring to FIG. 2 and FIG. 6, when the plug connector 1 and the receptacle connector 2 mate with each other, the contact portions 235f of each pair of signal terminals 235 of the receptacle connector 2 are electrically connected with the corresponding pair of signal conductive pads 122b, and the multiple wall portions 152 of the ground shielding cover 15 respectively cover and shield the free ends 235e of the multiple pairs of signal terminals 235, preferably, the ground shielding cover 15 covers and shields the free ends 235e of the multiple pairs of signal terminals 235 and the contact portions 235f of the multiple pairs of signal terminals 235, and the contact segments 236d of the multiple ground terminal 236 of the receptacle connector 2 abut against outer sides of the corresponding connecting portions 153 of the ground shielding cover 15 along the left-right direction D3, that is, the contact segment 236d of each ground terminal 236 will insert into between the two connecting portions 153 of the two adjacent shielding structures, which each are in form of inverted U-shape, and will abut against the outer side of the corresponding connecting portion 153 of the ground shielding cover 15, so the ground shielding cover 15 plays a shielding function when the plug connector 1 and the receptacle connector 2 mate with each other.

Therefore, as described above, an effect of the present disclosure lies in that, in the plug connector 1, by that the ground shielding cover 15 and the board 12 together encircle at least parts of the multiple pairs of signal conductive pads 122b, the multiple pairs of signal conductive pads 122b have better shielding effect, and in the receptacle connector 2, by that the first ground shielding member 24, the second ground shielding member 25 and the multiple ground terminals 236 together encircle the multiple pairs of signal terminals 235, similarly the multiple pairs of signal terminals 235 have better shielding effect, and when the plug connector 1 and the receptacle connector 2 mate with each other, the multiple ground terminals 236 of the receptacle connector 2 are electrically connected with the ground shielding cover 15, each pair of signal terminals 235 of the receptacle connector 2 are electrically connected with the corresponding pair of signal conductive pads 122b, the ground shielding cover 15 covers and shields the free ends 235e of the multiple pairs of signal terminals 235 or the free ends 235e and the contact portions 235f of the multiple pairs of signal terminals 235, which forms a complete shielding effect between the plug connector 1 and the receptacle connector 2, signal integrity can be better at a high transmission speed.

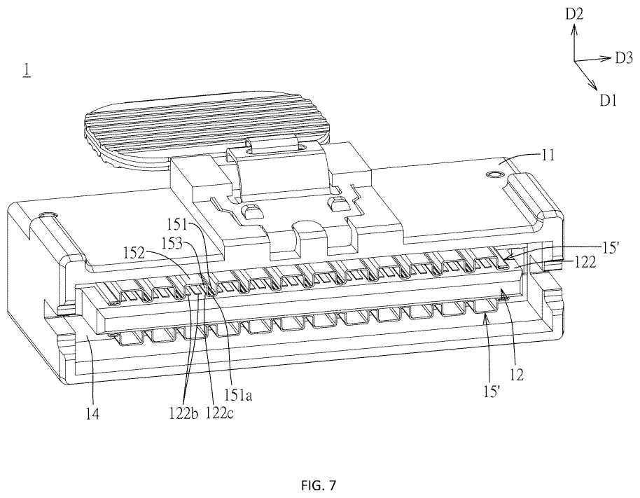

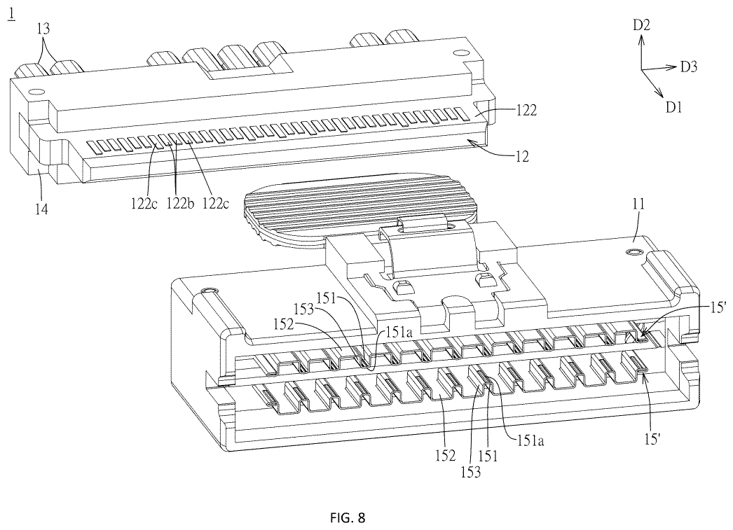

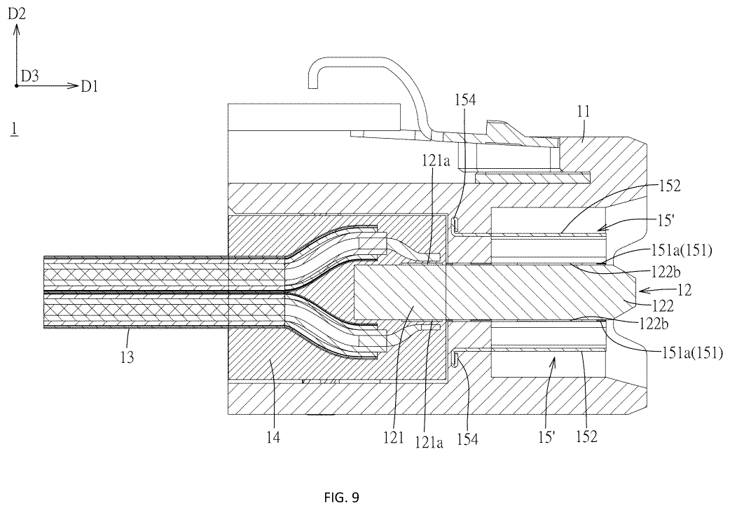

Referring to FIG. 7 to FIG. 9, a second embodiment of the connector assembly of the present disclosure differs from the first embodiment in that, in the second embodiment, the two ground shielding covers 15′ of the plug connector 1 are provided to the plug housing 11 by insert molding, and the multiple contact portions 151 of the ground shielding cover 15′ respectively press against the multiple ground conductive pads 122c. Each ground shielding cover 15′ further has multiple fixing portions 154 which are formed by bending respectively from rear ends of the multiple wall portions 152 toward a direction away from the multiple contact portions 151, and a cross section of each fixing portion 154 in the up-down direction D2 is in form of inverted U-shape, in other words, the fixing portion 154 is formed by bending twice relative to the wall portion 152, and the plug housing 11 will clad the multiple fixing portions 154 and an entire local segment of the ground shielding cover 15′ close to the rear ends of the multiple wall portions 152, by the design of the multiple fixing portions 154, an engagement strength between the plug housing 11 and the ground shielding cover 15′ may be strengthened. Moreover, the contact portion 151 has a bulging bar 151a which bulges toward a direction away from the wall portion 152, that is, toward the board 12, and is used to press against the corresponding ground conductive pad 122c, so as to more ensure that the contact portion 151 may indeed press against the ground conductive pad 122c. In the second embodiment, the board 12, the plurality of cables 13 and the cladding body 14 are together engaged in the plug housing 11 by a modular manner, and the ground conductive pads 122c of the board 12 are respectively in interference fit with the bulging bars 151a of the contact portions 151 of the two ground shielding covers 15′ to respectively contact the bulging bars 151a of the contact portions 151 of the two ground shielding covers 15′ with pressure.

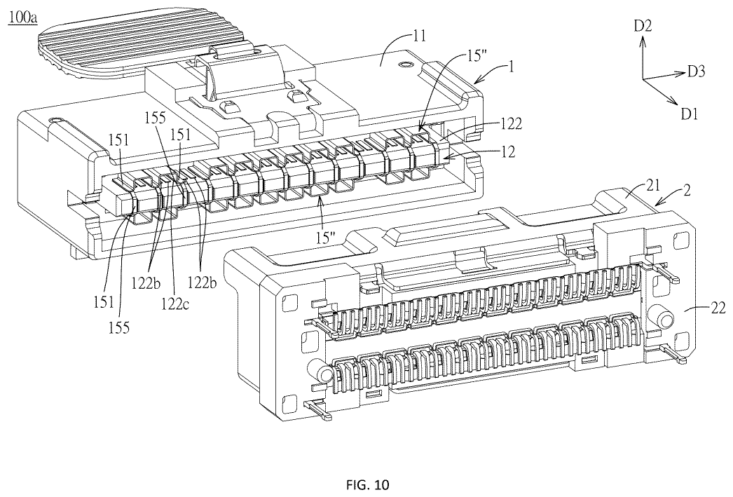

Referring to FIG. 10 to FIG. 14, a third embodiment of the connector assembly 100a of the present disclosure differs from the first embodiment in that, in the first embodiment, the upper surface and the lower surface of the board 12 each are provided one ground shielding cover 15, but in the third embodiment, each include multiple ground shielding covers 15″, that is the upper surface and the lower surface of the board 12 each are provided with multiple ground shielding covers 15″, each ground shielding cover 15″ includes multiple contact portions 151, multiple wall portions 152 and multiple connecting portions 153, or, also may be deemed as that each ground shielding cover 15 of the first embodiment is modified as a structure which is multiple discontinuous segments, such a design is to cooperate with a reason that the multiple pairs of signal terminals 235 of the receptacle connector 2 may include high-speed signal terminals and non-high-speed signal terminals, where requirement on shielding for the high-speed signal terminal is higher than requirement on shielding for the non-high-speed signal terminal, therefore, provided positions of the multiple ground shielding covers 15″ mainly cooperate with positions of the high-speed signal terminals. Moreover, in the third embodiment, further by that multiple connecting segments 155 are respectively connected between the contact portions 151 of the two ground shielding covers 15″ which are respectively positioned up and down, the corresponding ground shielding covers 15″ which are respectively positioned up and down are connected as an integral, as such, the shielding effect may be better.

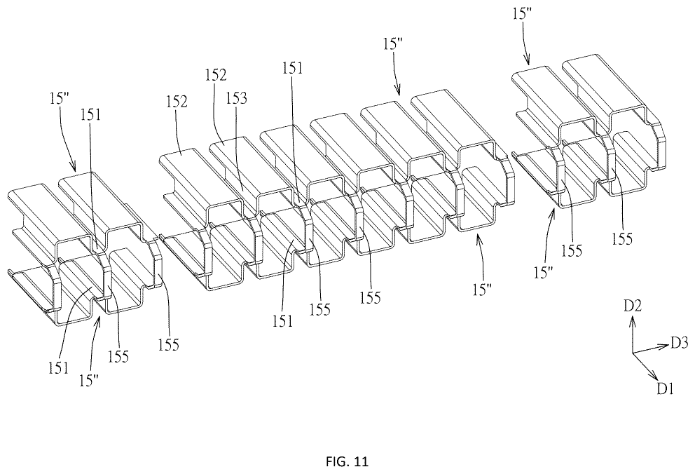

And as shown in FIG. 11, in the third embodiment, each wall portion 152 of the ground shielding cover 15″ is longer than the contact portion 151 and the connecting portion 153 in length along the front-rear direction D1.

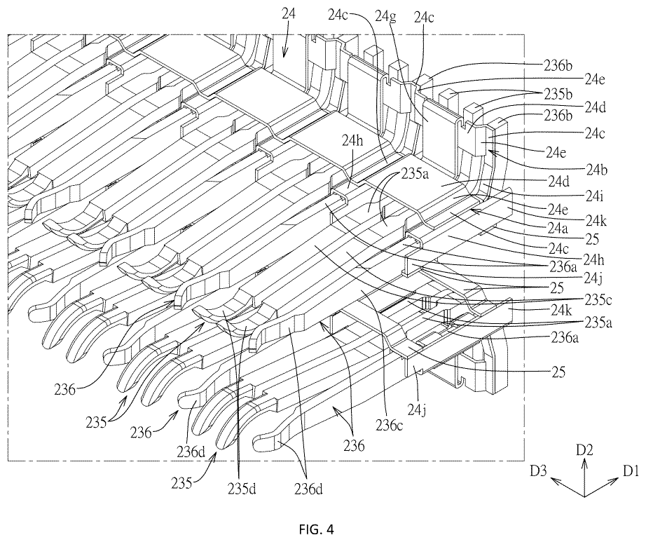

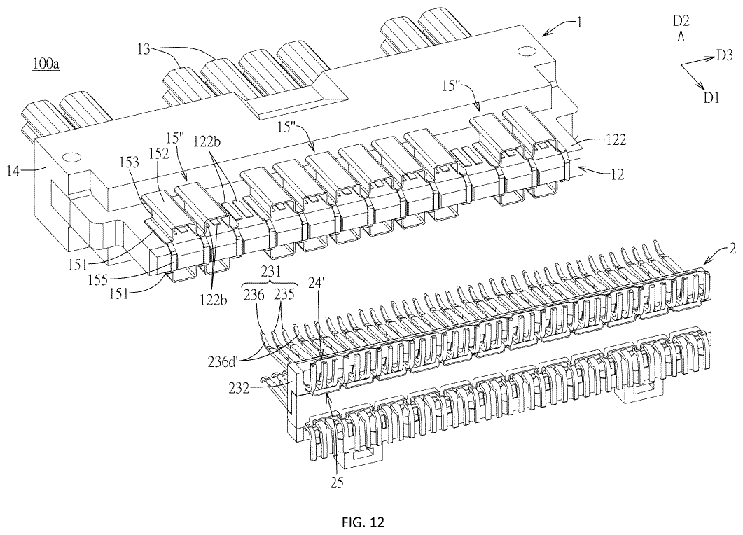

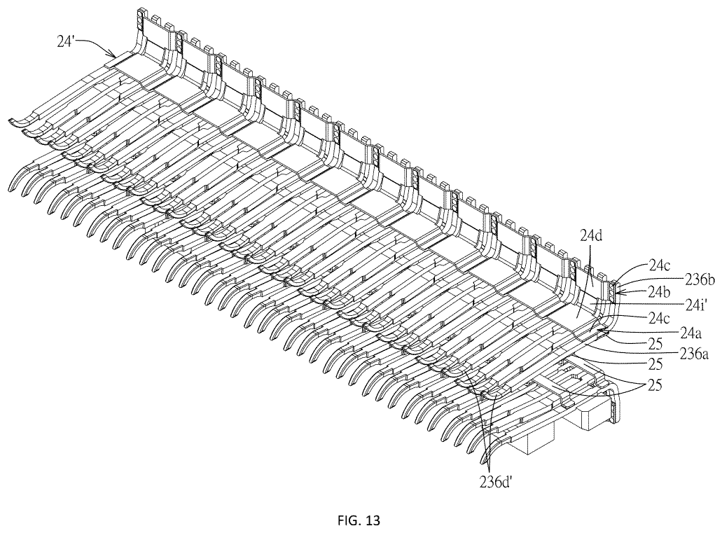

Referring to FIG. 12 to FIG. 14, moreover, in comparison with the first ground shielding member 24 of the first embodiment, the first ground shielding member 24′ of the receptacle connector 2 of the third embodiment, as shown in FIG. 13, omits the folded-back connecting portion 24g and the sleeve portion 24h of the first embodiment in FIG. 4, and the connecting segment 24i′ is connected between the wall portion 24d of the first shielding region 24a and the wall portion 24d of the second shielding region 24b, the contact portion 24c of the first shielding region 24a is in form of sheet shape and is welded and fixed to the fixing segment 236a of the ground terminal 236, the contact portion 24c of the second shielding region 24b is welded and fixed to the soldering segment 236b of the ground terminal 236.

And the first ground shielding member 24′ is directly provided to one sides of the multiple ground terminals 236 in the up-down direction D2 by welding, so as to be electrically connected to the multiple ground terminals 236. Furthermore, the two second ground shielding members 25 are the same as that in the first embodiment, and are provided to the other sides of the multiple ground terminals 236 in the up-down direction D2 by welding, so as to be electrically connected to the multiple ground terminals 236, and the two second ground shielding members 25 and the first ground shielding member 24′ form an effect of encircling the signal terminals 235.

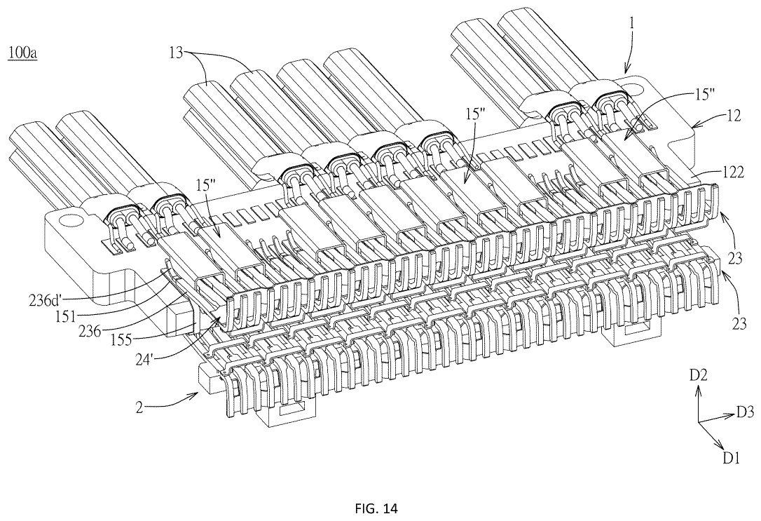

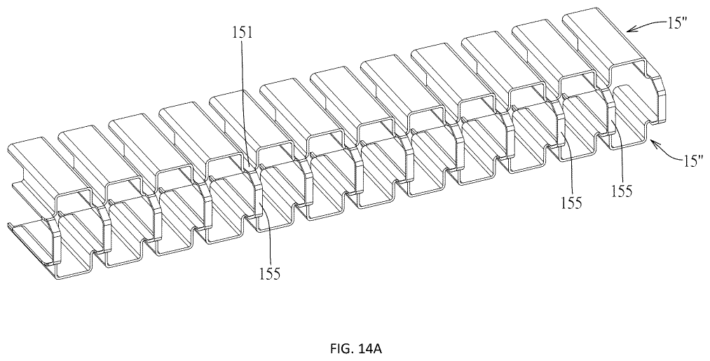

Furthermore, in the third embodiment, as shown in FIG. 13 and FIG. 14, the contact segment 236d′ of each ground terminal 236 of the receptacle connector 2 bends and bulges along the up-down direction D2, when the plug connector 1 and the receptacle connector 2 mate with each other, the contact segment 236d′ of the ground terminal 236 of the receptacle connector 2 abuts against the corresponding contact portion 151 of the ground shielding cover 15″ along the up-down direction D2 to be electrically connected with the ground shielding cover 15″, so the contact segment 236d′ of the ground terminal 236 and the ground shielding cover 15″ may have stabler contact.

It is further noted that, as shown in FIG. 14A, the multiple ground shielding covers 15″ which are provided on each surface of the board 12 also may be connected as an integral to be a continuous structure as the ground shielding cover 15 as shown in FIG. 2.

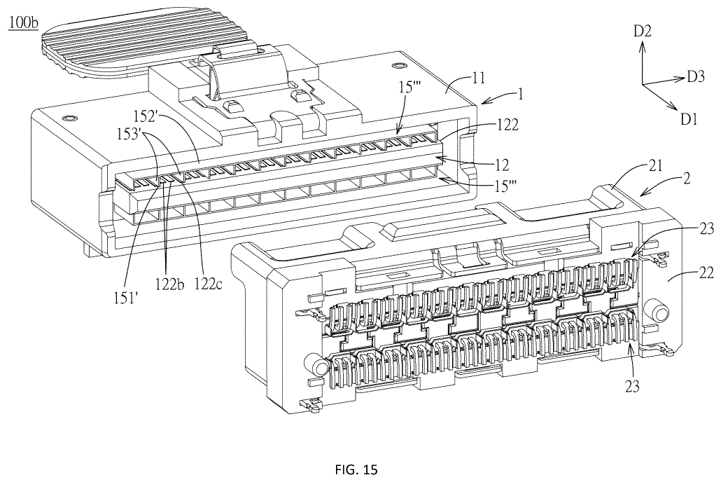

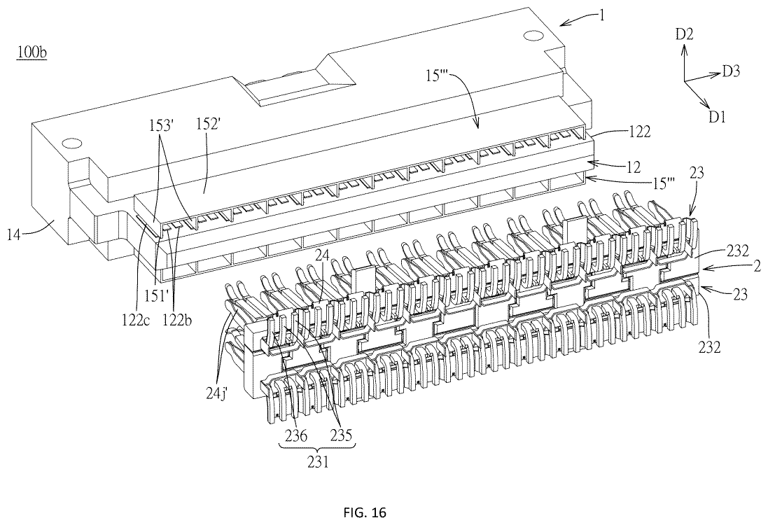

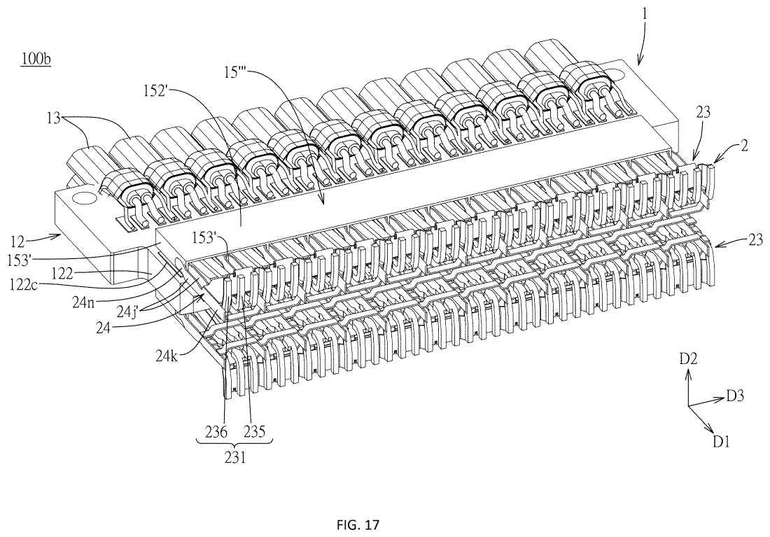

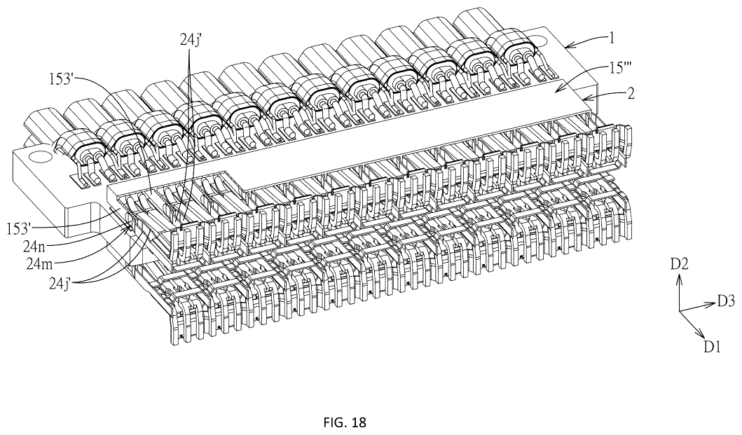

Referring to FIG. 15 to FIG. 18, a fourth embodiment of the connector assembly 100b of the present disclosure differs from the first embodiment in that, in an aspect of the plug connector 1, in comparison with that the ground shielding cover 15 of the first embodiment is in form of wave shape structure, the ground shielding cover 15′″ of the fourth embodiment is formed by metal die casting and is in form of grating shape, the ground shielding cover 15′″ has multiple contact portions 151′ which respectively contact the multiple ground conductive pads 122c, multiple wall portions 152′ which are positioned between the multiple contact portions 151′ and are respectively spaced apart from and correspond to the multiple pairs of signal conductive pads 122b, and multiple connecting portions 153′ which respectively connect the multiple contact portions 151′ and the multiple wall portions 152′. In the fourth embodiment, the multiple wall portions 152′ are connected as an integral flat plate shape, the multiple connecting portions 153′ are provided to be spaced apart from along the left-right direction D3, the multiple contact portions 151′ are regions of bottoms of the multiple connecting portions 153′ which respectively contact the multiple ground conductive pads 122c, so the multiple connecting portions 153′ are respectively connected between the multiple wall portions 152′, which form the flat plate shape, and the multiple contact portions 151′.

Moreover, in comparison with the first embodiment, each protruding piece 24j of the first ground shielding member 24 of the receptacle connector 2 is replaced by a pair of clamping pieces 24j′, or, also may deemed as that the contact segment of the ground terminal is replaced by the pair of clamping pieces 24j′, each clamping piece 24j′ extends along the front-rear direction D1 and has an abutting portion 24n which is used to contact the corresponding ground shielding cover 15′″ of the plug connector 1, the abutting portions 24n of each pair of clamping pieces 24j′ bend toward each other to define a clamping portion 24m. When the plug connector 1 and the receptacle connector 2 mate with each other, the abutting portions 24n of the clamping pieces 24j′ of the receptacle connector 2 abut against the corresponding connecting portions 153′ of the ground shielding cover 15″ along the left-right direction D3, specifically, in the fourth embodiment, each connecting portion 153′ of the ground shielding cover 15′″ totally has the abutting portions 24n of the two clamping pieces 24j′ to abut thereagainst respectively left and right, that is, the two the abutting portions 24n together clamp the connecting portion 153′.

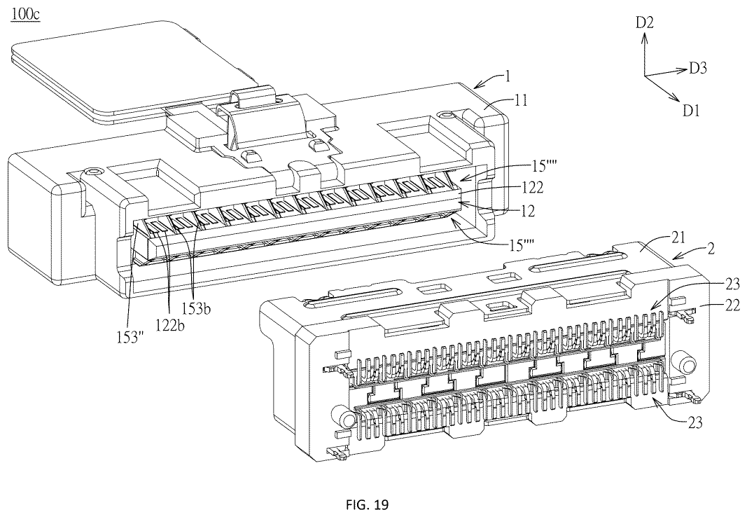

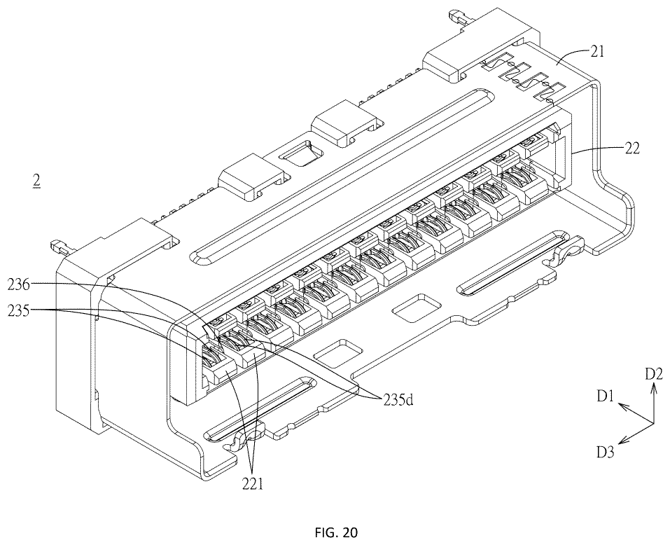

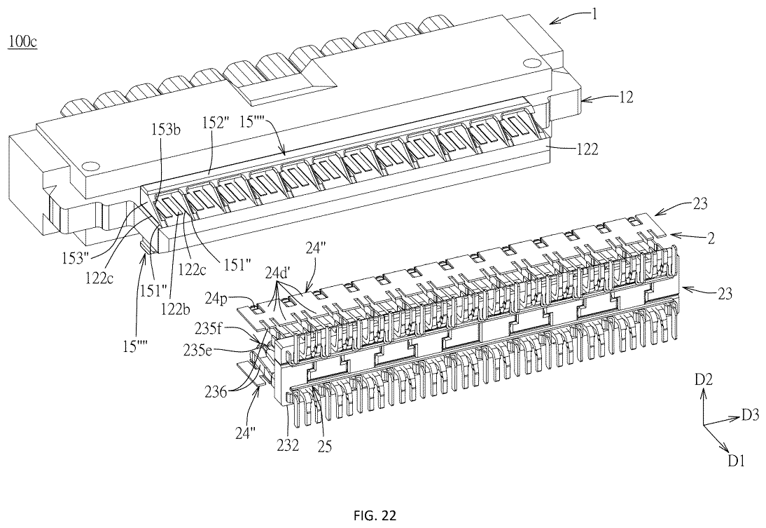

Referring to FIG. 19 to FIG. 23, a fifth embodiment of the connector assembly 100c of the present disclosure differs from the first embodiment in that, in the fifth embodiment, the two ground shielding covers 15″″ of the plug connector 1 are formed by metal die casting, a structure of the ground shielding cover 15″″ substantially is similar to that of the fourth embodiment and is in form of grating shape, the ground shielding cover 15″″ has multiple contact portions 151″ which respectively contact the multiple ground conductive pads 122c, multiple wall portions 152″ which are positioned between the multiple contact portions 151″ and are respectively spaced apart from and correspond to the multiple pairs of signal conductive pads 122b, and multiple connecting portions 153″ which respectively connect the multiple contact portions 151″ and the multiple wall portions 152″, the multiple contact portions 151″ similarly are regions of bottoms of the multiple connecting portions 153″ which contact the multiple ground conductive pads 122c respectively, a difference lies in that, each connecting portion 153″ is in form of plate wall shape and a surface of one of sides of each connecting portion 153″ in the left-right direction D3 is formed with a receiving recessed groove 153b, and front edges of the multiple connecting portions 153″ which face an inserting direction (that is, opposite to the arrow direction of the front-rear direction D1) each are an oblique surface which obliquely extends forwardly and downwardly, thus as shown in FIG. 22, the ground shielding cover 15″″ and the board 12 together encircle at least parts of the multiple pairs of signal conductive pads 122b.

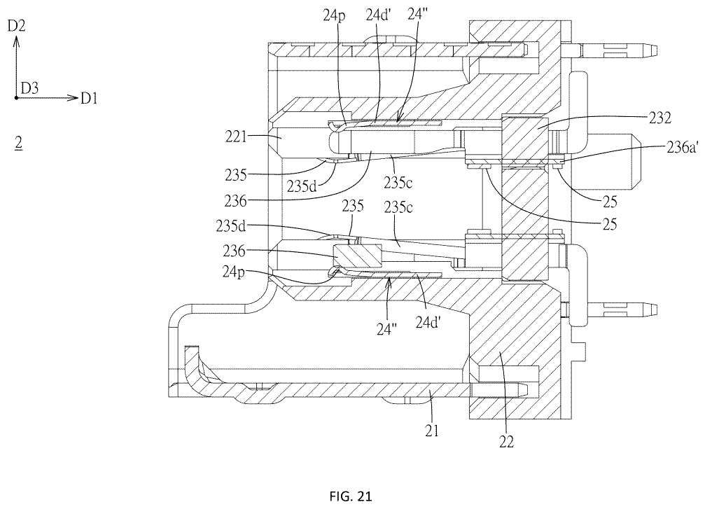

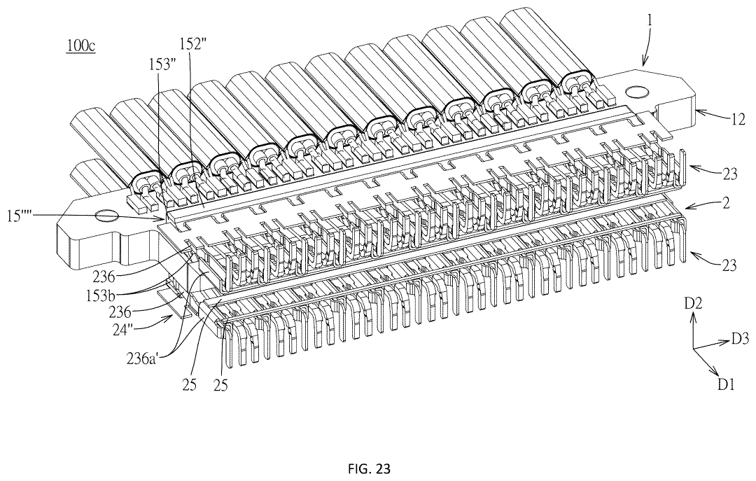

Moreover, the insulative body 22 of the receptacle connector 2 has multiple encircling walls 221 which respectively correspond to the contact segments 235d of the multiple pairs of signal terminals 235, the multiple encircling walls 221 each are in form of U-shape and each encircle a left side and a right side and tips of the contact segments 235d of the each pair of signal terminals 235, are used to protect the contact segments 235d of the multiple pairs of signal terminals 235 and respectively insert into shielding spaces which are respectively encircled together by the multiple connecting portions 153″ and the multiple wall portions 152″ of the ground shielding cover 15″″ and the board 12. Moreover, the first ground shielding member 24″ in the fifth embodiment may be entirely and substantially in form of sheet shape and is provided to the insulative body 22 by insert molding to press against the multiple ground terminals 236. And in the fifth embodiment, as shown in FIG. 23, the fixing segment 236a′ of the ground terminal 236 is in form of U-shaped structure. The first ground shielding member 24″ substantially is in form of sheet shape and is formed by stamping to include multiple wall portions 24d′ and multiple pressing portions 24p, as shown in FIG. 21 and FIG. 22, the multiple wall portions 24d′ are parts of the sheet which are not stamped, the multiple wall portions 24d′ are respectively spaced apart from and correspond to the elastic arm segments 235c of the multiple pairs of signal terminals 235, the multiple pressing portions 24p each are in form of elastic arm structure, extend along the front-rear direction D1, and are used to contact the multiple ground terminals 236 respectively. And the two second ground shielding members 25 each are in form of strip sheet shape and are electrically connected to the fixing segments 236a′ of the multiple ground terminals 236 by welding.

When the plug connector 1 and the receptacle connector 2 mate with each other, the multiple ground terminals 236 of the receptacle connector 2 respectively abut against the multiple connecting portions 153″ of the corresponding ground shielding covers 15″″ along the left-right direction D3, and are respectively received in the receiving recessed grooves 153b of the multiple connecting portion 153″ of the ground shielding cover 15″″, therefore, the receiving recessed groove 153b of the connecting portion 153″ has a function to guide and limit the ground terminal 236. The ground shielding cover 15″″ covers and shields the free ends 235e of the multiple pairs of signal terminals 235 or the free ends 235e and the contact portions 235f of the multiple pairs of signal terminals 235.

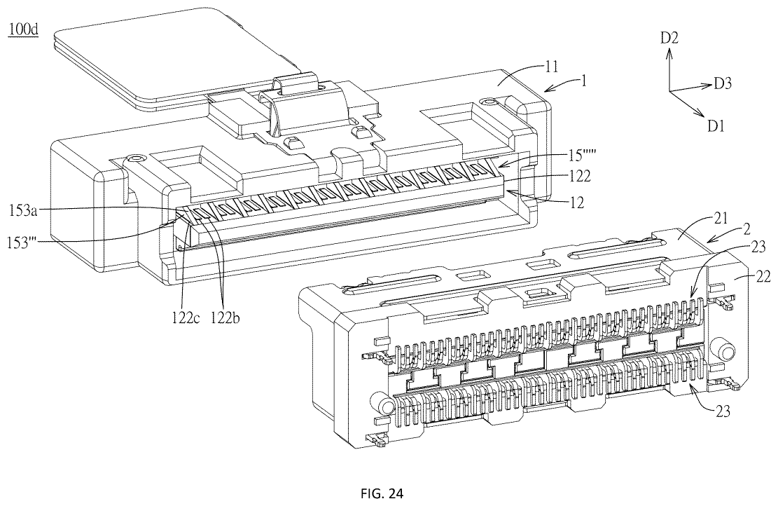

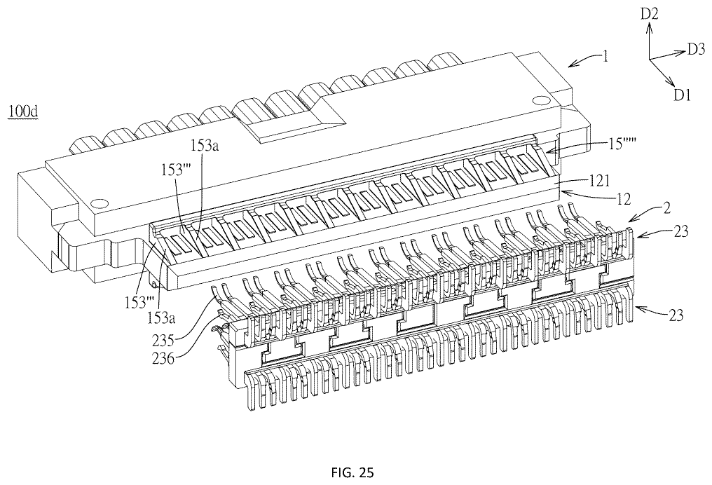

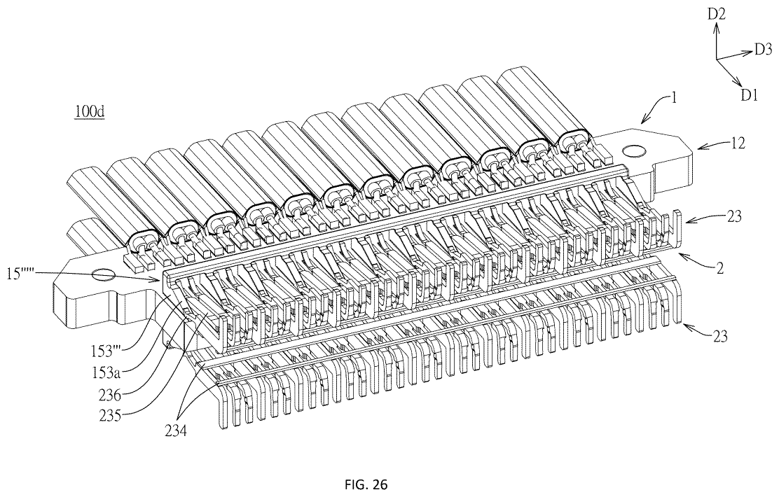

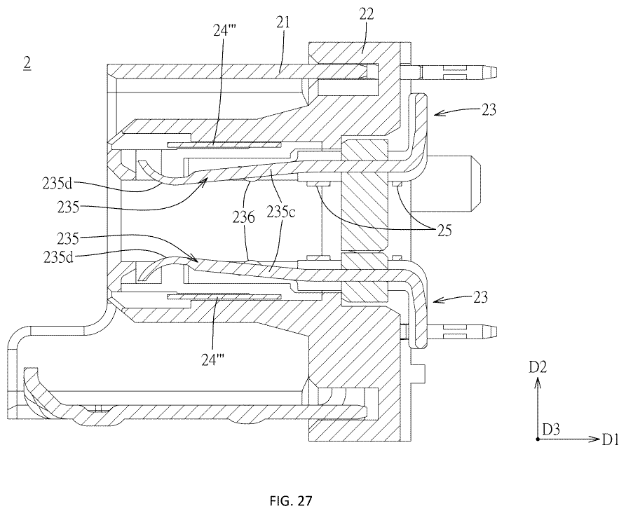

Referring to FIG. 24 to FIG. 27, a sixth embodiment of the connector assembly 100d of the present disclosure differs from the fifth embodiment in that, in the sixth embodiment, the connecting portion 153′″ of the ground shielding cover 15′″″ of the plug connector 1 does not have the receiving recessed groove 153b of the fifth embodiment, but has a contact oblique surface 153a, which is oblique toward the up-down direction D2, in a direction which faces the inserting direction (that is, opposite to the arrow direction of the front-rear direction D1) of the receptacle connector 2.

Moreover, in the receptacle connector 2, the ground terminal 236 is shorter than the signal terminal 235 in length in the front-rear direction D1, and the first ground shielding member 24′″ is in form of sheet shape and is provided in the insulative body 22, and the first ground shielding member 24′″ are spaced apart from the multiple pairs of signal terminals 235, a position of the first ground shielding member 24′″ approximately corresponds to the elastic arm segments 235c and the contact segments 235d of the multiple pairs of signal terminals 235 and the first ground shielding member 24′″ does not directly contact the multiple pairs of signal terminals 235, but similarly, the first ground shielding member 24′″, the second ground shielding member 25 and the multiple ground terminals 236 together encircle the multiple pairs of signal terminals 235.

When the plug connector 1 and the receptacle connector 2 mate with each other, the multiple ground terminals 236 of the receptacle connector 2 respectively abut against the contact oblique surfaces 153a of the multiple connecting portions 153′″ of the corresponding ground shielding cover 15′″″ along the up-down direction D2, to be electrically connected with the ground shielding cover 15′″″, which thus can similarly attain a complete shielding effect to be formed between the plug connector 1 and the receptacle connector 2 when the plug connector 1 and the receptacle connector 2 mate with each other.

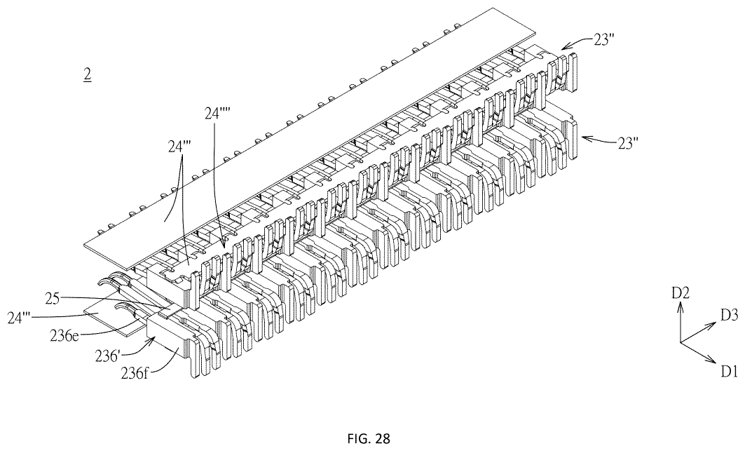

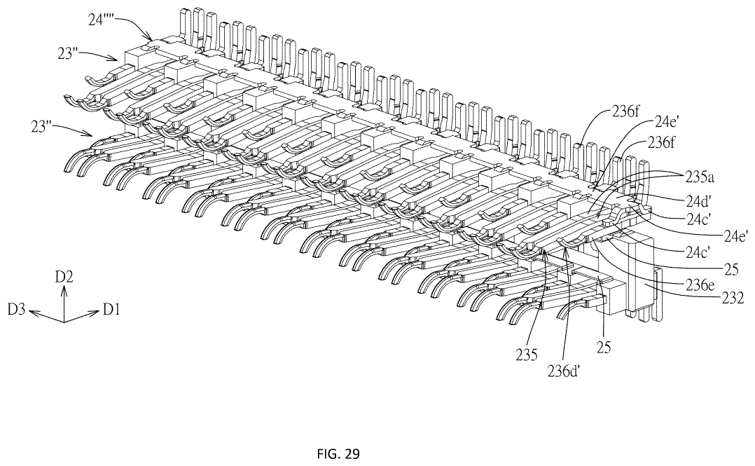

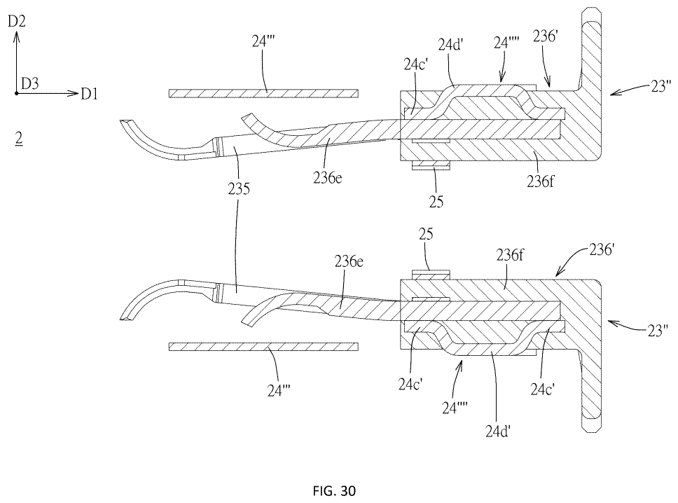

Referring to FIG. 28 to FIG. 30, a seventh embodiment of the connector assembly of the present disclosure differs from the sixth embodiment in that, in the seventh embodiment, each ground terminal 236′ of each terminal module 23″ of the receptacle connector 2 has a metal portion 236e which is a metal material, and an conductive plastic portion 236f which is formed by that an electrical conductive plastic clads the metal portion 236e, where, the metal portion 236e constitutes a part which is equivalent to the elastic arm segment 236c and the contact segment 236d of the ground terminal 236 of the first embodiment, the conductive plastic portion 236f clads the metal portion 236e to constitute a part which is equivalent to the fixing segment 236a and the soldering segment 236b of the ground terminal 236 of the first embodiment. Moreover, the first ground shielding member 24″″ of the receptacle connector 2 is provided to the conductive plastic portions 236f of the multiple ground terminals 236′ by insert molding, and contacts the metal portions 236e of the multiple ground terminal 236′. The first ground shielding member 24″″ has multiple contact portions 24c′, multiple wall portions 24d′ which are positioned between the multiple contact portions 24c′ and respectively correspond to the fixing segments 235a of the multiple pairs of signal terminals 235, and multiple connecting portions 24e′ which each are connected between the adjacent the contact portion 24c′ and the adjacent the wall portion 24d′. In the seventh embodiment, the multiple contact portions 24c′ are provided in pairs which each are along the front-rear direction D1, and each pair of the contact portions 24c′ contact positions of a part of the metal portion 236e of the ground terminal 236′, which is equivalent to a fixing segment, toward opposite directions, and the contact portions 24c′ are cladded by the conductive plastic portion 236f, and every two pairs of the contact portions 24c′ are therebetween connected to the wall portion 24d′ via the connecting portions 24e′, so that the multiple wall portions 24d′ are arranged along the left-right direction D3, the multiple contact portions 24c′, which are in pairs, are also arranged along the left-right direction D3. In addition, in the seventh embodiment, another first ground shielding member 24′″, which is in form of sheet shape as the sixth embodiment, is further provided, so the another first ground shielding member 24′″ cooperates with the first ground shielding member 24″″ to encircle the signal terminals, a better shielding effect is attained. The seventh embodiment is similarly provided with one second ground shielding members 25.

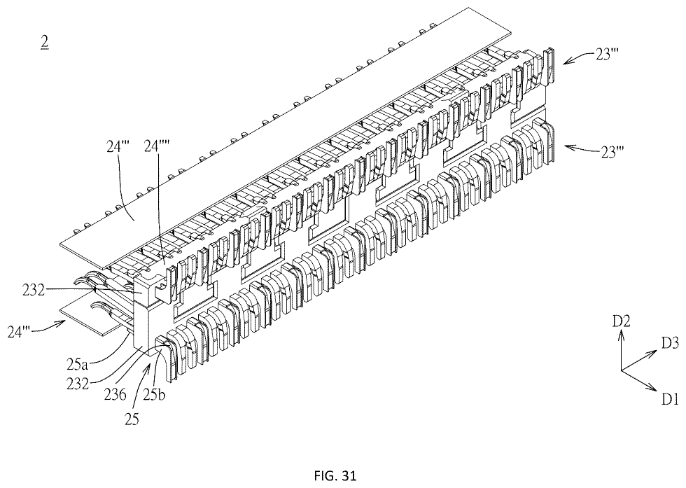

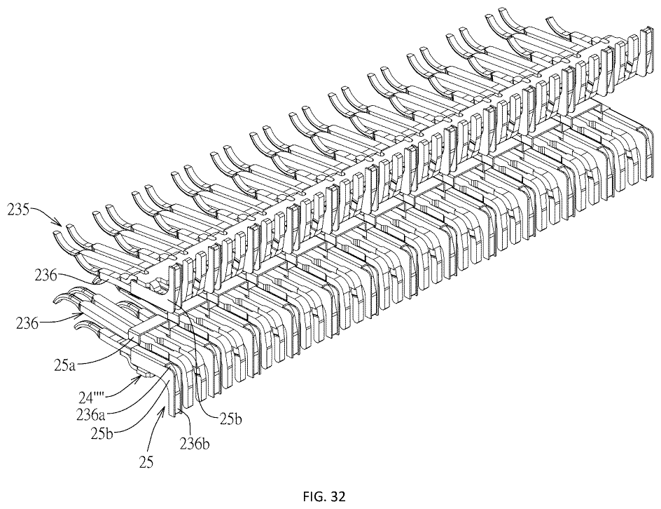

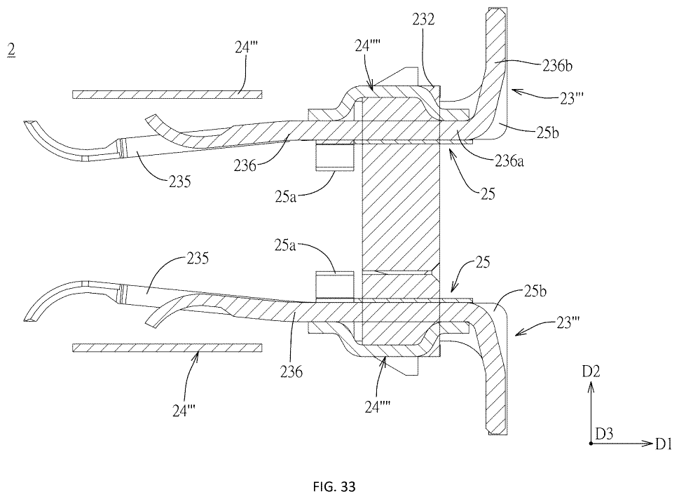

Referring to FIG. 31 to FIG. 33, an eighth embodiment of the connector assembly of the present disclosure is the same as the seventh embodiment in the first ground shielding member 24″″ and the another first ground shielding member 24′″, differs from the seventh embodiment in that, in the eighth embodiment, the ground terminal 236 of each terminal module 23′″ of the receptacle connector 2 entirely is a metal material, the second ground shielding members 25 has a second ground shielding piece 25a and multiple bushing portions 25b, the bushing portion 25b sheathes the fixing segment 236a and the soldering segment 236b of the ground terminal 236 and one end of the bushing portion 25b contacts the second ground shielding piece 25a, so as to play an shielding effect. The first ground shielding member 24″″ and the second ground shielding piece 25a and the multiple bushing portions 25b are provided to the corresponding insulative base 232 by insert molding, and the first ground shielding member 24″″ and the second ground shielding piece 25a contact the fixing segments 236a of the multiple ground terminals 236.

In conclusion, the ground shielding cover 15 and the board 12 of the plug connector 1 of the present disclosure together encircle at least parts of the multiple pairs of signal conductive pads 122b on the board mating portion 122 of the board 12. Moreover, the first ground shielding member 24, the second ground shielding member 25 and the multiple ground terminals 236 of the receptacle connector 2 of the present disclosure together encircle the multiple pairs of signal terminals 235 of the terminal module 23. Furthermore, when the plug connector 1 and the receptacle connector 2 mate with each other, the multiple ground terminals 236 of the receptacle connector 2 are electrically connected with the ground shielding cover 15, each pair of signal terminals 235 of the receptacle connector 2 are electrically connected with the corresponding pair of signal conductive pads 122b, where, the ground shielding cover 15 covers and shields the free ends 235e of the multiple pairs of signal terminals 235 or the free ends 235e and the contact portions 235f of the multiple pairs of signal terminals 235. Therefore, it can prevent electromagnetic interference from affecting signal transmission, so the connectors can have higher signal integrity at a high transmission speed.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

1-41. (canceled)

42. A connector assembly, comprising:
a plug connector, comprising:
a board which has a board mating portion, a surface of the board mating portion being provided with multiple pairs of signal conductive pads and multiple ground conductive pads which are respectively provided at two sides of each pair of signal conductive pads, and
a ground shielding cover which is mounted to the surface of the board mating portion, the ground shielding cover and the board together encircling at least parts of the multiple pairs of signal conductive pads; and
a receptacle connector, comprising:
an insulative body; and
a terminal module which is provided to the insulative body, the terminal module comprising:
a terminal group which comprises multiple pairs of signal terminals and multiple ground terminals;
an insulative base which partially clads the terminal group;
a first ground shielding member positioned at first side of the multiple ground terminals; and
a second ground shielding member positioned at a second side of the multiple ground terminals, wherein
the first ground shielding member, the second ground shielding member, and the multiple ground terminals together encircle the multiple pairs of signal terminals.

43. The connector assembly of claim 42, wherein, when the plug connector and the receptacle connector mate with each other, the multiple ground terminals of the receptacle connector are electrically connected with the ground shielding cover of the plug connector, each pair of signal terminals of the receptacle connector are electrically connected a corresponding pair of signal conductive pads of the plug connector, and the ground shielding cover covers and shields free ends of the multiple pairs of signal terminals.

44. The connector assembly of claim 42, wherein the ground shielding cover comprises multiple contact portions which respectively contact the multiple ground conductive pads, multiple wall portions which are positioned between the multiple contact portions, and multiple connecting portions which connect the multiple contact portions and the multiple wall portions.

45. The connector assembly of claim 44, wherein
a surface of each connecting portion is formed with a receiving recessed groove; and
when the plug connector and the receptacle connector mate with each other, each ground terminal of the receptacle connector is respectively positioned in a receiving recessed groove of a connecting portion.

46. The connector assembly of claim 42, wherein each ground terminal comprises a contact segment that bends and bulges and, when the plug connector and the receptacle connector mate with each other, contacts the ground shielding cover of the plug connector.

47. A plug connector, comprising:
a board which has a board mating portion, a surface of the board mating portion comprising multiple pairs of signal conductive pads and multiple ground conductive pads which are respectively provided at two sides of each pair of signal conductive pads; and
a ground shielding cover mounted to the surface of the board mating portion, the ground shielding cover and the board together encircling at least parts of the multiple pairs of signal conductive pads.

48. The plug connector of claim 47, wherein
the ground shielding cover comprises multiple contact portions which respectively contact the multiple ground conductive pads, multiple wall portions which are positioned between the multiple contact portions, and multiple connecting portions which connect the multiple contact portions and the multiple wall portions.

49. The plug connector of claim 48, wherein a surface of each connecting portion is formed with a receiving recessed groove.

50. The plug connector of claim 48, wherein each connecting portion comprises a contact oblique surface.

51. The plug connector of claim 48, wherein the multiple contact portions, the multiple wall portions, and the multiple connecting portions are a same in length along a front-rear direction.

52. The plug connector of claim 48, wherein the multiple wall portions are longer than the multiple contact portions along a front-rear direction.

53. The plug connector of claim 48, wherein
the plug connector further comprises a plug housing;
the ground shielding cover further comprises multiple fixing portions which are formed by bending respectively from the multiple wall portions toward a direction away from the multiple connecting portions; and
the plug housing clads the multiple fixing portions and a part of the ground shielding cover.

54. The plug connector of claim 47, wherein
the ground shielding cover comprises a first ground shielding cover mounted to a first surface of the board; and
the plug connector further comprises a second ground shielding cover mounted to a second surface of the board opposite the first surface.

55. The plug connector of claim 47, wherein contact portions of the first ground shielding cover are connected with contact portions of the second ground shielding cover by connecting segments.

56. A receptacle connector, comprising:
an insulative body; and
a terminal module which is provided to the insulative body, the terminal module comprising:
a terminal group which comprises multiple pairs of signal terminals and multiple ground terminals;
an insulative base which partially clads the terminal group;
a first ground shielding member positioned at a first side of the multiple ground terminals; and
a second ground shielding member positioned at a second side of the multiple ground terminals, wherein
the first ground shielding member, the second ground shielding member, and the multiple ground terminals together encircle the multiple pairs of signal terminals.

57. The receptacle connector of claim 56, wherein
the first ground shielding member is electrically connected with first sides of the multiple ground terminals in an up-down direction; and
the second ground shielding member is electrically connected with second sides of the multiple ground terminals in the up-down direction.

58. The receptacle connector of claim 56, wherein
each signal terminal and each ground terminal comprises a fixing segment and a soldering segment that bends relative to the fixing segment;
the first ground shielding member comprises a first shielding region and a second shielding region which are connected with each other to be substantially in form of L-shape;
the first shielding region is used to shield the fixing segments of the multiple pairs of signal terminals; and
the second shielding region is used to shield the soldering segments of the multiple pairs of signal terminals.

59. The receptacle connector of claim 58, wherein the first shielding region and the second shielding region each comprise multiple contact portions which are electrically connected with the multiple ground terminals respectively, multiple wall portions which are respectively positioned between the multiple contact portions, and multiple connecting portions between the multiple contact portions and the multiple wall portions.

60. The receptacle connector of claim 59, wherein
the first ground shielding member further comprises multiple sleeve portions and multiple connecting segments;
the multiple sleeve portions respectively sheathe the fixing segments of the multiple ground terminals; and
the multiple connecting segments respectively connect the multiple sleeve portions and the multiple contact portions of the second shielding region.

61. The receptacle connector of claim 59, wherein
the first ground shielding member further comprises multiple folded-back connecting portions; and
each folded-back connecting portion is folded back from a wall portion of the second shielding region and extends and connects to a wall portion of the first shielding region.
